(19) United States
(12) Patent Application Publication
(10) Pub. No.: US 2017/0046766 A1
(43) Pub. Date: Feb. 16, 2017

(54) ENHANCED SELECTION TOOL FOR HVAC SYSTEM COMPONENTS

(71) Applicant: Trane International Inc., Davidson, NC (US)

(72) Inventor: Franklin K. Rolles, Denver, NC (US)

(73) Assignee: Trane International Inc., Davidson, NC (US)

(21) Appl. No.: 15/236,813

(22) Filed: Aug. 15, 2016

Related U.S. Application Data
(60) Provisional application No. 62/204,726, filed on Aug. 13, 2015.

(51) Int. Cl. G06Q 30/06; G06Q 10/10

(52) U.S. Cl. CPC G06Q 30/0627; G06Q 10/1095

(57) ABSTRACT

A product selection tool is disclosed that utilizes input from consumers and third party data sources to dynamically enhance the selection of HVAC components. Specific and estimated data characterizing existing HVAC components is used to identify suitable replacement HVAC components based on type, size, energy efficiency, and other system requirements in view of regional climate data.

### CROSS-REFERENCE TO RELATED APPLICATION

This application claims the benefit of and priority to U.S. Provisional Application Ser. No. 62/204,726, filed Aug. 13, 2015, the entirety of which is hereby incorporated by reference herein for all purposes.

### BACKGROUND

1. Technical Field

The present disclosure generally relates to heating, ventilation and air conditioning (HVAC) technology. In particular, the disclosure relates to a tool for proper selection of residential HVAC components.

2. Background of Related Art

Product selection for consumer goods can be simple or complex depending on the level of understanding consumers have of the product, and the complexity of the product itself. For example, buying a simple product, such as a book, is easy; buying a complex product that most people understand, such as a computer, is also relatively easy. Historically, for complex products or custom work that is not-well understood, a professional may provide a proposal or a quote during an in-home visit. However, technology is changing that process. For example, a person can now go online to perform interior design for the home which previously required a professional designed to visit the home.

However, purchasing a Heating, Ventilation, and Air Conditioning (HVAC) system remains a daunting process. HVAC is a complex mechanical system, and since most people have little or no knowledge of how HVAC systems work, buying an HVAC system can be a very difficult process. Most consumers face HVAC replacement decisions perhaps once or twice in their lifetime, and most consumers do not know much about the process. Currently, it is extremely difficult for consumers to understand HVAC products and no HVAC manufacturers are known to provide key specifics, such as price, online. Rather, the industry relies on traditional in-home visits by an HVAC professional to evaluate the consumer's situation and to provide a quotation to the consumer. But, as noted above, consumers are increasingly using the Internet to learn about the products they purchase, and, when possible, purchase the products directly online. The HVAC industry has not responded to the trends and needs of online consumers, and most HVAC manufactures do not provide specific product information which would enable consumers to make an informed HVAC system purchasing decision.

Whereas online product selection is common in other industries, it is not common in HVAC, primarily because of a perception that the particular characteristics of an existing HVAC system cannot be determined until an HVAC professional visits the home. During such a visit, the HVAC professional will perform detailed calculations to properly design and size a system. Sometimes, however, a professional only performs rough estimates during their first visit, rather than detailed calculations.

A system that addresses consumer needs for simultaneously learning about and selecting HVAC products prior to, or instead of, scheduling an in-home appointment with an HVAC professional, and that provides pricing transparency and dynamic pricing, in a consumer-friendly manner, would be a welcome advance.

### SUMMARY

In one aspect, the present disclosure is directed to a system which effectively gathers information about the home, and the existing HVAC system, by utilizing input from the consumer and by retrieving technical information from internal or third party data aggregators. The system performs rough estimates instantly and online. The system provides a consumer with knowledge and pricing of potential replacement HVAC equipment ahead of an HVAC professional's scheduled in-home visit; upon which the professional can confirm the on-line recommendations made by the system.

In one aspect, the present disclosure is directed to a computer system for selecting HVAC products, comprising: a screen display interface; a memory; a processor; a network interface; and a program that, when loaded in to the memory and executed by the processor, causes the processor to: query a residence street address and zip code; lookup climate from zip code; import residential data from another computer through the network interface based on residence street address; from the imported data, extract required home information comprising square footage of living space and age; query a type and total number of existing HVAC system(s); estimate the size and energy efficiency of the existing HVAC system(s) from the required home information; determine replacement HVAC products based on the type, size and energy efficiency determined in previous steps; present and query preferences concerning the replacement HVAC products; and dynamically present replacement HVAC products and prices for said products on the screen display interface based on the preferences specified.

In another aspect, the present disclosure is directed to a program that when loaded in to the memory and executed by the processor, further causes the processor to: query zip code and required home information comprising square footage of living space and age.

In another aspect, the present disclosure is directed to a program that when loaded in to the memory and executed by the processor, further causes the processor to: query model number(s) and total number of existing HVAC system(s); and lookup the type, size and energy efficiency of the existing HVAC system(s) from the model number(s).

In another aspect of the present disclosure, the size is estimated from square footage of living space, a factor based on climate and total number of existing HVAC system(s).

In another aspect of the present disclosure, the estimated size equals the square footage of living space divided by the factor based on climate and the number of systems.

In another aspect of the present disclosure, the factor is 500.

In another aspect of the present disclosure, the energy efficiency is based on estimated age of the existing HVAC system(s).

In another aspect of the present disclosure, the estimated age of the existing HVAC system(s) is the maximum of the home age or 15 years.

In another aspect of the present disclosure, the energy efficiency equals the average SEER of historical HVAC equipment having an age equal to the estimated age.

In another aspect of the present disclosure, the preferences include temperature consistency, control type, noise, humidity, air quality, and energy savings.

In another aspect of the present disclosure, the program, when loaded in to the memory and executed by the processor, further causes the processor to: query contact information; lookup an HVAC professional proximal to the street address; and schedule an appointment with the HVAC professional.

In yet another aspect, the present disclosure is directed to a non-transient computer readable storage media comprising a program that, when loaded in to memory and executed by a processor in a computer, causes the processor to: query a residence street address and zip code; lookup climate from zip code; import residential data from another computer through a network interface based on residence street address; from the imported data, extract required home information comprising square footage of living space, age and climate; query a type and total number of existing HVAC system(s); estimate the size and energy efficiency of the existing HVAC system(s) from the required home information; determine replacement HVAC products based on the type, size and energy efficiency determined in previous steps; present and query preferences concerning the replacement HVAC products; and dynamically present replacement HVAC products and prices for said products on a screen display interface based on the preferences specified.

In another aspect of the present disclosure, the program further causes the processor to: query zip code and required home information comprising square footage of living space and age.

In another aspect of the present disclosure, the program further causes the processor to: query model number(s) and total number of existing HVAC system(s); and lookup the type, size and energy efficiency of the existing HVAC system(s) from the model number(s).

In yet another aspect, the present disclosure is directed to a method of selecting HVAC products, comprising: (a) querying a residence street address and zip code; (b) performing a lookup of climate based on zip code from a database; (c) retrieving residential data from a computer through a network interface based on the residence street address; (d) extracting required home information comprising square footage of living space, age and climate from the imported data; (e) querying a type and total number of existing HVAC system(s); (f) estimating the size and energy efficiency of the existing HVAC system(s) from the required home information; and (g) determining replacement HVAC products based on the type, size and energy efficiency determined in previous steps.

In another aspect of the present disclosure, the method further comprises: (h) querying preferences concerning the replacement HVAC products; and (i) presenting replacement HVAC products and prices for said products based on the preferences specified.

In another aspect of the present disclosure, estimating the size of the existing HVAC system(s) from the required home information comprises calculating the square footage of living space divided by the total number of existing HVAC system(s) and a factor based on climate.

In another aspect of the present disclosure, the factor is 500.

### BRIEF DESCRIPTION OF THE DRAWINGS

Various embodiments of the disclosed system and method are described herein with reference to the drawings wherein:

FIG. 1 is a block diagram that illustrates the computer architecture of a system for selecting HVAC products in accordance with an embodiment of the present disclosure;

FIG. 2 is a flow diagram illustrating a method of selecting HVAC products in accordance with an embodiment of the present disclosure;

FIG. 3 is an exemplary screen image of a web page for inputting residence data in accordance with an embodiment of the present disclosure;

FIG. 4 is an exemplary screen image of a web page for inputting nameplate HVAC equipment information in accordance with an embodiment of the present disclosure;

FIG. 5 is an exemplary screen image of a web page for confirming existing HVAC equipment information in accordance with an embodiment of the present disclosure;

FIG. 6 is an exemplary screen image of a web page for selecting preferences and displaying recommended HVAC equipment, prices, payments, rebates and energy savings in accordance with an embodiment of the present disclosure; and

FIG. 7 is an exemplary screen image of a web page for scheduling an appointment with an HVAC professional in accordance with an embodiment of the present disclosure.

The various aspects of the present disclosure mentioned above are described in further detail with reference to the aforementioned figures and the following detailed description of exemplary embodiments.

### DETAILED DESCRIPTION

Embodiments of the present disclosure utilize input received from the consumer online and from third party data providers to retrieve data about the home and an existing HVAC system. The system makes assumptions about the consumer's home, and the climate where the home is located, to determine the most likely system that the consumer currently has. To confirm or refine the level of accuracy, the system provides functionality for the consumer to enter the model number of the existing equipment directly and will retrieve technical data by using a third party reference tool to get the technical specifications of the system to be replaced. If the consumer doesn't wish to gather the model numbers, he or she will be presented with an interactive tool aimed at helping the consumer understand the various HVAC system types. Thus, the consumer can then select the type of system that he or she currently has.

Generally, most consumers will replace an existing system with a new system of a similar type and size. This is because the technical requirements, such as size, are based on the properties of the home, such as square footage to be heated or cooled. A new HVAC system will generally be better and more energy efficient than a replaced HVAC system.

Notably, embodiments of the present disclosure also provides a method of obtaining detailed data on a contemporaneous basis from diverse public sources and for using that data for determining technical aspects of a replacement HVAC system for the consumer. The system gathers primary home characteristic and climate data from third party listing entities, such as ZILLOW®, other residential real estate information services, and weather data services.

Embodiments of the present disclosure may be described herein in terms of functional block components, code listings, optional selections and various processing steps. It should be appreciated that such functional blocks may be realized by any number of hardware and/or software components configured to perform the specified functions. For example, the embodiments of the present disclosure may employ various integrated circuit components, e.g., memory elements, processing elements, logic elements, look-up tables, and the like, which may carry out a variety of functions under the control of one or more microprocessors or other control devices.

Similarly, software elements of embodiments of the present disclosure may be implemented with any programming or scripting language such as C, C++, C#, Java, COBOL, assembler, PERL, Visual Basic, Python, CGI, PHP, or the like, with the various algorithms being implemented with any combination of data structures, objects, processes, routines or other programming elements.

The object code created for the computers can preferably be executed by any general purpose computer such as a personal computer having an appropriate operating system such as Linux, Windows® or OSX® and an appropriate browser such as Internet Explorer®, Firefox®, Chrome® or Safari®.

Further, it should be noted that embodiments of the present disclosure may employ any number of conventional techniques for data transmission, signaling, data processing, network control, and the like.

It should be appreciated that the particular implementations shown and described herein are illustrative of the disclosure and its best mode and are not intended to otherwise limit the scope of the present disclosure in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present disclosure may be embodied as a method, a data processing system, a device for data processing, and/or a computer program product. Accordingly, embodiments of the present disclosure may take the form of a software embodiment stored in memory that is run by a processor, or an entirely hardware embodiment. Furthermore, embodiments of the present disclosure may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present disclosure is described below with reference to block diagrams and flowchart illustrations of methods, apparatus (e.g., systems), and computer program products according to various aspects of the disclosure. It will be understood that each functional block of the block diagrams and the flowchart illustrations, and combinations of functional blocks in the block diagrams and flowchart illustrations, respectively, can be implemented by computer program instructions. In this description, as well as in the drawings, like-referenced numbers represent elements which may perform the same, similar, or equivalent functions.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of embodiments of the present disclosure may consist of any combination of databases or components at a single location or at multiple locations, wherein each database or system includes any of various suitable security features, such as firewalls, access codes, encryption, de-encryption, compression, decompression, and/or the like.

The scope of the disclosure should be determined by the appended claims and their legal equivalents, rather than by the examples given herein. For example, the steps recited in any method claims may be executed in any order and are not limited to the order presented in the claims. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.” Moreover, no element is essential to the practice of the disclosure unless specifically described herein as “critical” or “essential.”

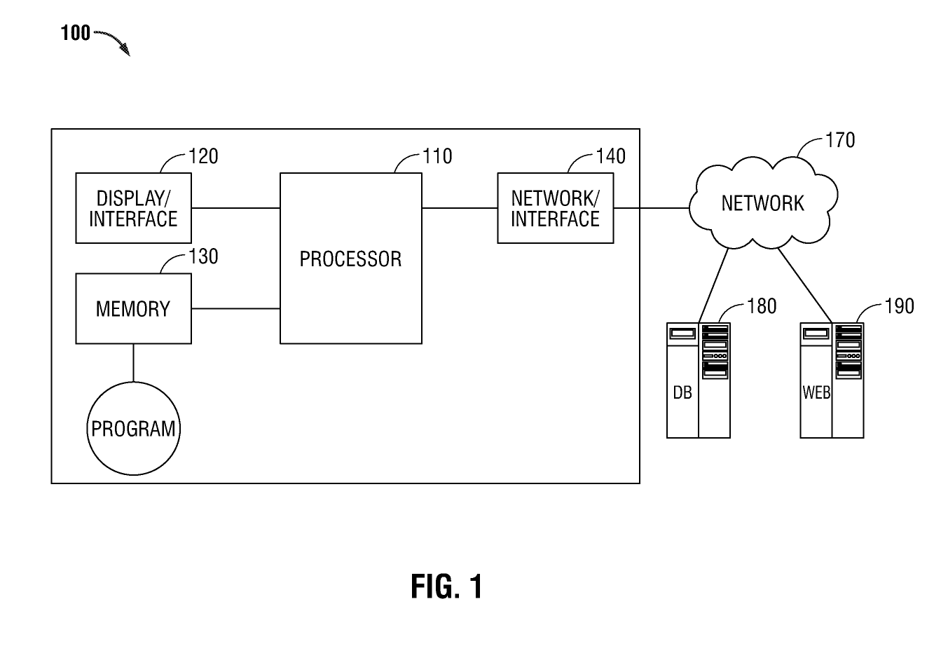

FIG. 1 is a block diagram that illustrates an exemplary embodiment of a system and method in accordance with the present disclosure for selecting HVAC products. In this embodiment, the system and method of the present disclosure are directed to system 100 in communication with a database server 180 and a web server 190 through a network 170, such as the Internet. As shown on FIG. 1, system 100 includes a processor 110, a display/interface 120, a memory 130, a network interface 140, and a computer program 160. System 100 is coupled through network interface 140 to one or more computers on network 170 that communicate data with system 100. Network 170 may comprise, for example, the Internet, a wide area network (WAN), or a local area network (LAN). Network 170 may include a plurality of network computers or server computers (not shown), each of which may be operatively interconnected. Where network 170 comprises the Internet, data communication may take place over communication links via an Internet communication protocol (UDP/IP or TCP/IP). Where network 170 comprises a wireless network, data communication may take place over communication links via a wireless data protocol such as, without limitation, CDMA2000 or W-CDMA. Similarly, where network 170 communications comprise data, voice and video, communication may take place via an Internet communication protocol or a wireless protocol.

System 100 comprises software program 160 that is loaded into memory 130 and executed by processor 110 in system 100. As is well-known in the art, system 100 could equally be embodied as a client/server software system, where data processing tasks are performed on computing devices on network 170 with which system 100 communicates. In such an embodiment, software program 160 comprises a Web server application that runs on a Web server 190 that listens for TCP/IP (transport control protocol/Internet protocol) connections on a well-known port, typically port 80, and receives standard HTTP (hyper-text transfer protocol) requests on that port that corresponds to a particular URL (universal resource locator) that indicates Web pages and other information requested, typically by Web browser, on system 100. In an exemplary embodiment, a Web server application comprises Apache webserver software published by the Apache Software Foundation and a collection of software modules that generate HTML (hyper-text markup language) Web pages. In alternative embodiments, the functions performed by Web server computer 190 are split among several server computers, for example, having components of Web server application executed on computers different from database server 180. Furthermore, these servers may be geographically separated and, for example, coupled through network 170.

Memory 130 may include dynamic random access memory, read-only memory, or persistent storage.

In addition, system 100 retrieves information from one or more databases stored on database server 180 in communication with system 300 via network 170. A database server application runs on database server 180 coupled to system 100, and provides an interface to the information stored in databases to application software modules in program 160 that execute on system 100. In a preferred embodiment, the database is a relational database, which includes a number of interrelated tables. Database server application is preferably an SQL (structured query language) server that accepts queries according to SQL syntax and provides responses to those queries. Database server application can perform stored database procedures comprising complex queries stored in SQL syntax on database server computers coupled to system 100. Such queries may involve multiple fetching processes from more than one table in the tables that comprise the database. Stored database procedures are stored in a file system on database server 180.

In a preferred embodiment, software program 160 on system 100 comprises a Web browser, such as Internet Explorer®, Firefox®, Chrome®, Safari® or other Web browser pre-loaded into memory 130 of system 100, or readily-available for download from the Internet into memory 130. Such browsers retrieve Web pages from a Web server in response to inputs on display/interface 120. Web pages are loaded into memory 130 and then rendered on display/interface 120. In an alternative embodiment, a dedicated, client-based application is installed on system 100, wherein such client-based application may use alternate communication protocols from HTTP (hyper-text transfer protocol).

Display/interface 120 comprises controls that are preferably graphically represented buttons with symbols commonly found in many Web pages to permit entry of information or selection of actions. Display/interface 120 may include a keyboard, mouse or other pointing device, or other information or control input device that affects the operation of system 100, as is well known in the art. Display/interface 120 may also comprise a microphone that provides the consumer with a means to convey digitized audio information.

Display/interface 120 comprises a CRT (cathode ray tube) or LCD (liquid crystal display), or other visual display device as is commonly known in the art. Display/interface 120 may further comprise speakers that receive digitized audio signals and emit audio output audible to the consumer. As is well known in the art, speakers may also be in a headset that comprises a microphone.

Under control of program 160, processor 110 receives consumer location and other information via consumer input. Under further control of program 160, processor 110 forms queries to Web server 190. Web server 190 may in turn form further queries to database server 180. Database server 180 may form responses to the queries of Web server 190, which can analyze the supplied information, and return responses to the queries of processor 110.

### System Operation

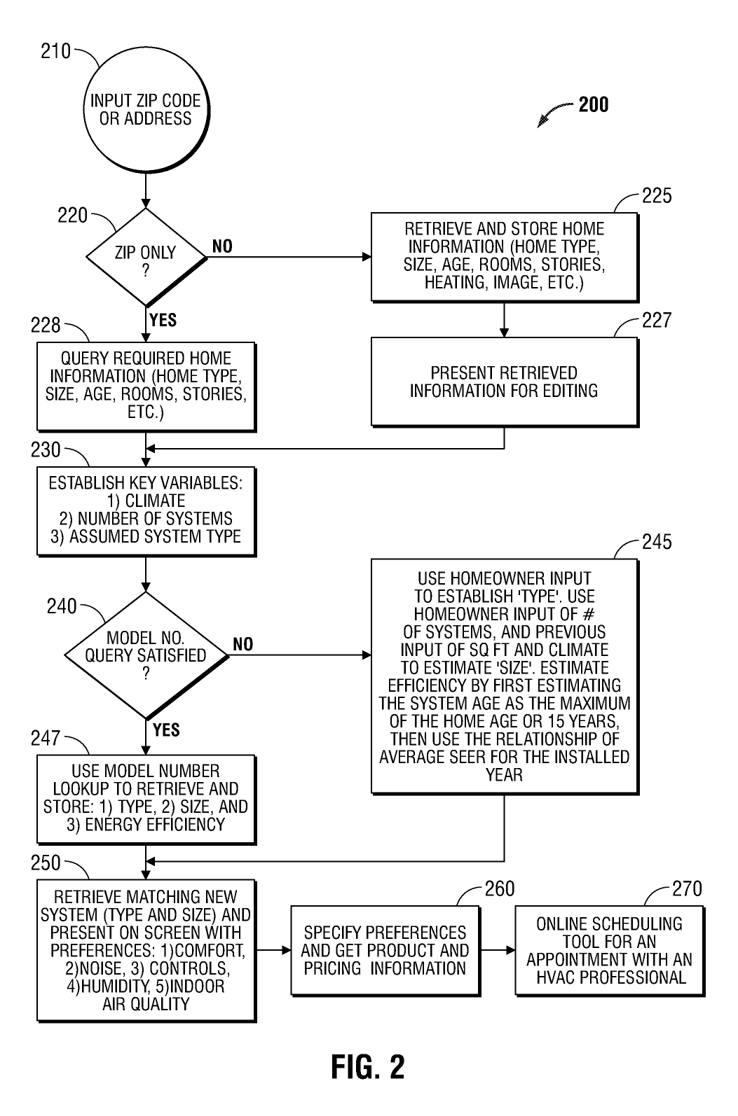

FIGS. 2-7 illustrate a method of recommending and selecting HVAC products in accordance with the present disclosure. The first objective to recommending a new system is to understand what type and size of equipment the consumer currently has. Previously, determining the type and size of a system could only be done by an HVAC professional during an in-home visit.

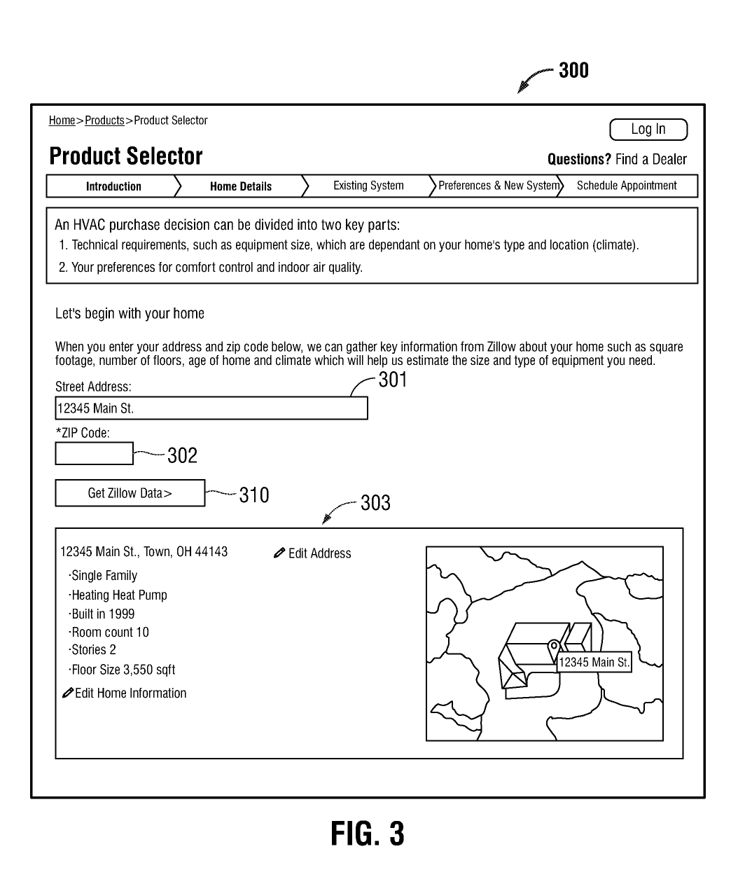

With reference to FIG. 2, a method 200 of the present disclosure begins with step 210 in which program 160 directs processor 110 to receive data indicating the consumer's full address and zip code. Such query is made available to the consumer on display 120, as indicated in FIG. 3. FIG. 3 is an exemplary screen image of a web page 300 for inputting residence data such as street address 301 and zip code 302.

Returning to flow diagram FIG. 2, in step 220, program 160 directs processor 110 to form a web query to server 190 containing information entered in step 210. Program 160 formulates a query that indicates the entered street address, if any, and the zip code where the home is located. Upon receiving the query, server 190 evaluates whether only the zip code was entered, or the entire street address.

If the entire street address was entered upon clicking the “Get Zillow Data” box 310, flow continues in step 225 with program 160 directing processor 110 to provide a web query to server 190, which in turn retrieves data about the home from third party data aggregators, such as Zillow®, to retrieve data about the home. Such data is then returned to system 100 by server 190 in the form of a web page, such as the lower portion illustrated in FIG. 3. It should be understood any suitable data aggregator(s) may be employed additionally or alternatively to Zillow®.

In step 227, the consumer may edit the address of the home, and the characteristics retrieved by server 190, such as whether the home is a single family home, the type of heating system, the year that the home was built, the number of rooms, the number of stories, and the square footage of the living space. Such exemplary information is displayed in a lower portion 303 of FIG. 3.

Alternatively, in step 228, if merely the zip code were entered, but not the street address, then program 160 directs processor 110 to query the consumer to enter the characteristics of their home manually.

Next, in step 230, program 160 directs processor 110 to retrieve key variables established by server 190 about the consumer's home, including climate, the number of systems present, and the assumed system type and size. For example, server 190 may perform a database query to look up the highest percentage, i.e., most prevalent type of system historically sold in that zip code, to assume which type of HVAC system that the consumer most likely has. In addition, based on the data obtained about the home, server 190 may perform a block calculation based on the square footage of living space to determine the size of HVAC system needed. In addition, server 190 may estimate the expected energy efficiency rating of the equipment, based on the age of the home.

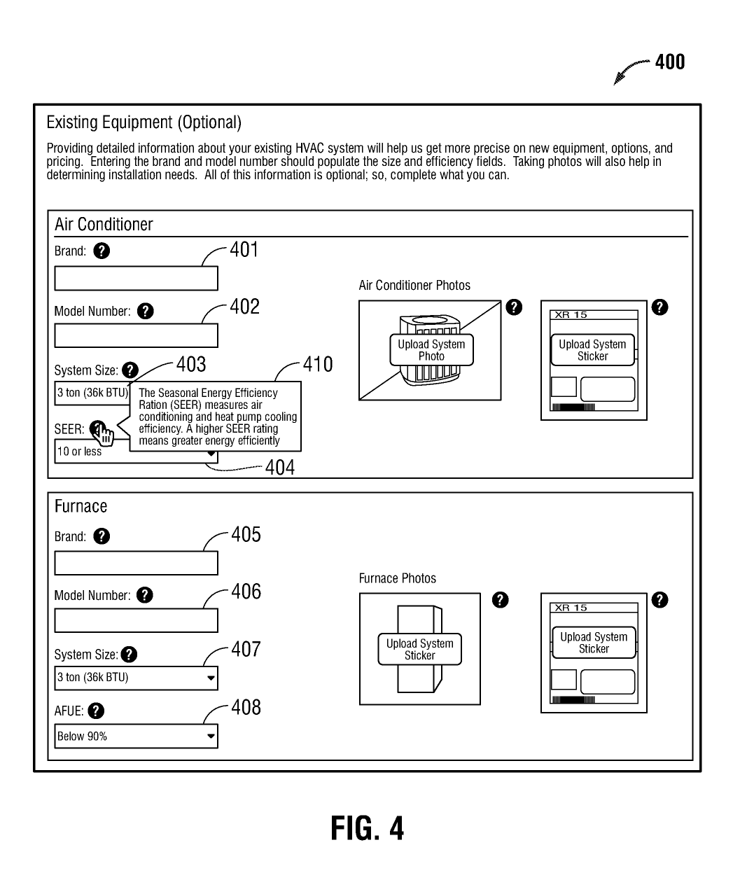

To confirm or refine the level of accuracy, in step 240, program 160 directs processor 110 to query the consumer about detailed nameplate information concerning existing HVAC equipment in the home. Because the location of such equipment may not be apparent to the consumer, or may not be readily accessible, this step is optional. FIG. 4 is an exemplary screen image of a web page 400 for inputting nameplate HVAC equipment information. As shown in FIG. 4, the consumer may enter air conditioner brand 401, model number 402, system size 403, and seasonal energy efficiency rating (SEER) 404, as well as the furnace brand 405, model number 406, system size 407, and annual fuel utilization efficiency (AFUE) 408 from the existing furnace in the home. Pop-up messages 410 provide useful tips to the consumer to improve comprehension of the various inputs being confirmed or solicited. Program 160 directs processor 110 to formulate a web query to server 190 comprising this information.

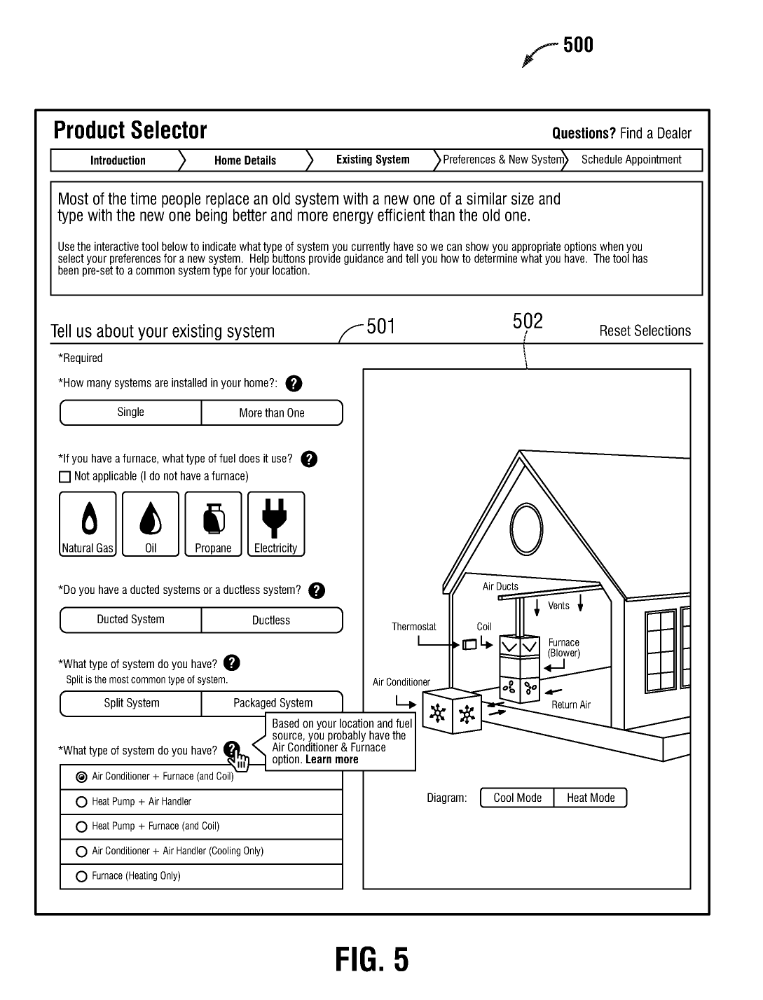

In step 245, if the consumer fails to enter nameplate model numbers, server 190 uses the previous consumer input to establish the likely type of system present. Server 190 would predict the type of system based on the zip code entered by the consumer. Server 190 would predict the size of the system based on the consumer's previous entry of the square footage of living space and number of stories of the home. Typically, the size of an air conditioner is calculated in tons by dividing the square footage of living space by 500, and further by the number of systems. Finally, server 190 would establish an estimated efficiency rating based on the system type and age of the home, up to a maximum of 15 years, and then use the relationship of average SEER for the year of installation from historical sales data. Server 190 would then send a web page back to the consumer to confirm or clarify the presumptions made about the existing system. Program 160 directs processor 110 to present the consumer with an interactive tool aimed at helping the consumer understand the various HVAC system types, such that the consumer can select a system type that the consumer currently has. This step is graphically illustrated in FIG. 5. FIG. 5 is an exemplary screen image of a web page 500 for confirming existing HVAC equipment information. Preferably, the default choices are illustrated in the left portion 501 of web page 500 to guide the consumer through the confirmation process.

Alternatively, in step 247, where the consumer provided nameplate model number information, server 190 performs a database lookup to cross reference the technical information about the existing HVAC system. Such information includes the type of system, size, and energy efficiency rating. Then server 190 would return a web page, such as FIG. 5, populated with the information determined by the database lookup. Program 160 directs processor 110 to display the web page 500 on display 120 to confirm the information shown, such as the screen image illustrated in FIG. 5.

In either case of alternative steps 245 and 247, as illustrated in FIG. 5, program 160 directs processor 110 to change the right portion 502 of web page 500 shown in display 120 based on the consumer's selections concerning the existing system. Right portion 502 changes dynamically in response to changes in the selections in left portion 501 of web page 500 to illustrate the homeowner's existing system in a visually satisfying manner.

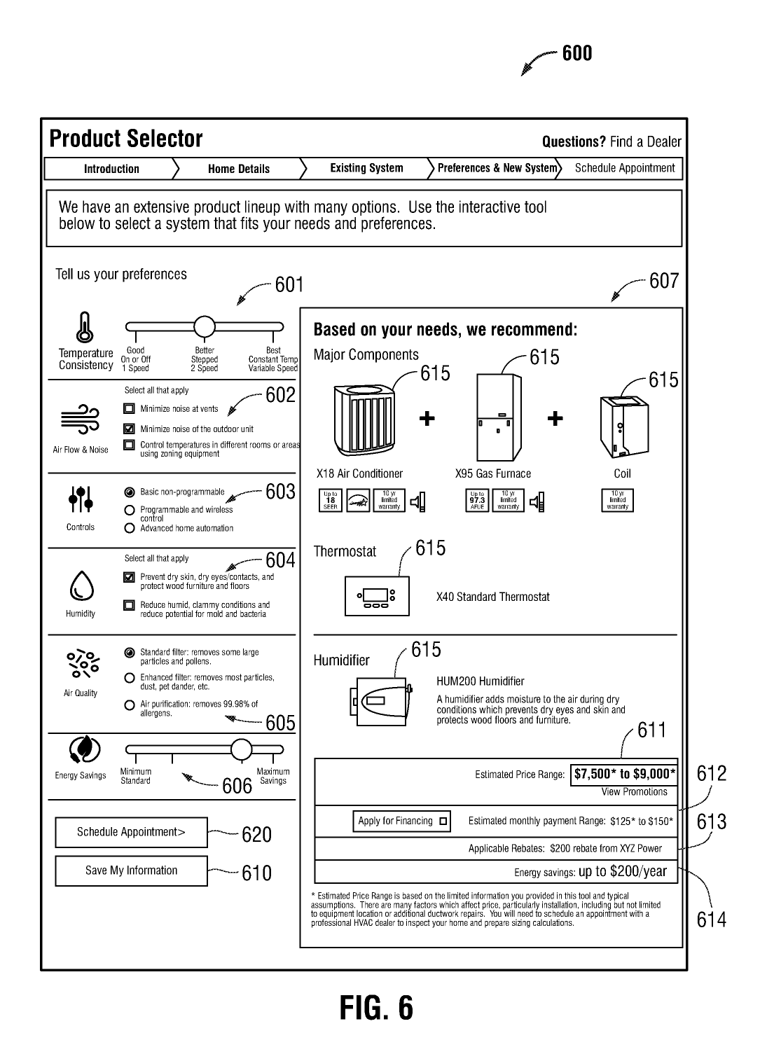

In step 250, program 160 directs processor 110 to query server 190 for a replacement system. Server 190 then returns a web page 600 providing the major components based on a database lookup of equipment of suitable type, size and energy efficiency ratings, and provides selection of consumer preferences. Such preferences include temperature consistency 601, air flow and noise 602, controls 603, humidity 604, air quality 605 and energy savings 606. Processor 110 would present an interactive web page on display 120 when received, as directed by program 160, as illustrated in FIG. 6. FIG. 6 is an exemplary screen image of a web page for selecting preferences and displaying recommended HVAC equipment, prices, payments, rebates and energy savings.

Returning to FIG. 2, in step 260, program 160 directs processor 110 to display preferences to the consumer, such as those illustrated in FIG. 6, and to update the HVAC system recommendations 607 based on consumer preference selection. In addition, estimated price range 611, monthly payment range 612, applicable utility rebates 613, and energy savings 614 are displayed, based on information received from the consumer and exchanged with server 190. It should be noted that, as the consumer adjusts his or her preferences, the HVAC system recommendations 607 (illustrated by the images, information, and price) will dynamically change, as indicated on FIG. 6. In addition to the price 611 of a new system, the monthly payments 612, rebates 613, and energy efficiency sayings 614, as well as graphics 615 of the selected HVAC components, will be generated and displayed in a dynamic fashion.

In addition, as shown in FIG. 6, the consumer can save selections by clicking box 610.

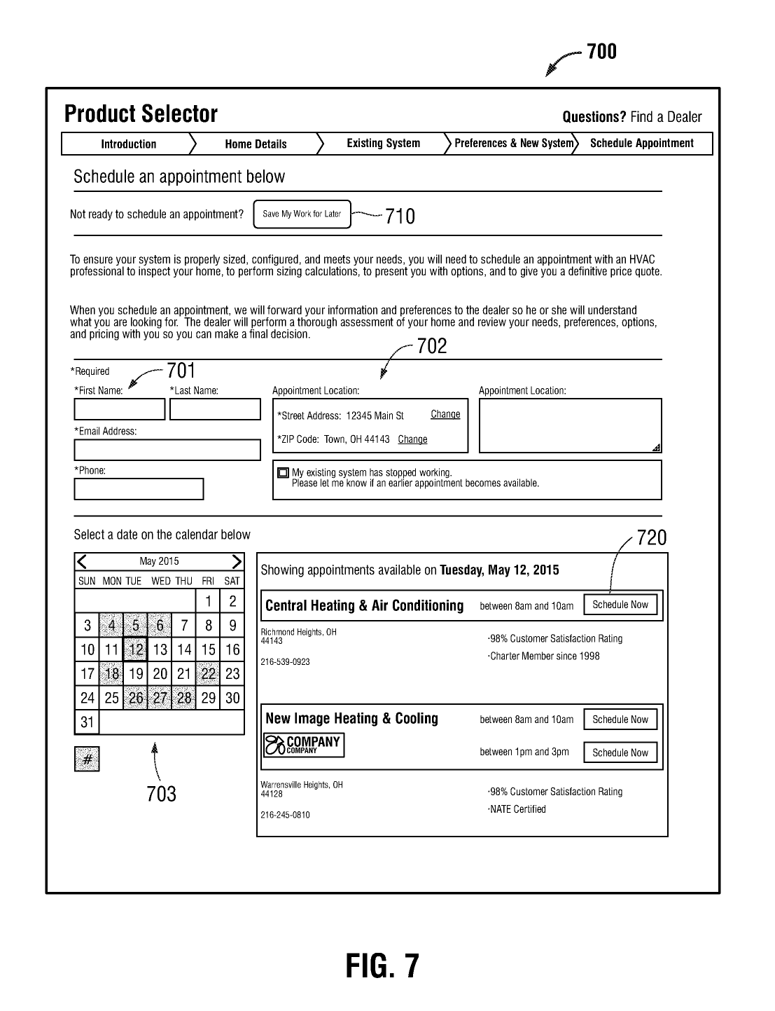

When the consumer is ready, as indicated by clicking box 620 illustrated in FIG. 6, flow continues to step 270 in FIG. 2. In step 270, program 160 directs processor 110 to permit the consumer to select and schedule an appointment with a local HVAC professional. Program 160 may further direct processor 110 to send the consumer's selections for the new system to the professional and to forward appointment scheduling confirmation back to the consumer. This process is illustrated in more detail in connection with FIG. 7.

FIG. 7 is an exemplary screen image of a web page 700 for scheduling an appointment with an HVAC professional. As shown in FIG. 7, if the consumer clicks box 710, then the current state of information is saved for later use. As illustrated in FIG. 7, program 160 directs processor 110 to provide a common calendar user interface on display 120, listing local HVAC professionals and available appointment times. The consumer merely has to enter contact information 701 and appointment location 702, then select a date and time 703 with an HVAC professional and click a “Schedule Now” box 720. When the professional arrives for the appointment he or she can confirm the product selection and provide a formal quotation.

The product selection system enables a simultaneous learn-and-select environment for the HVAC buying process whereby the consumer presses a button or other user interface element to see onscreen images and details, such as, for example, an equipment, preference, or pricing change. Providing this environment will increase customer confidence in their purchase decision and provide the consumer with a base of knowledge to communicate with the HVAC professional during a scheduled appointment.

The description of embodiments of the present disclosure is merely exemplary in nature and, thus, variations that do not depart from the gist of the disclosure are intended to be within the scope of the disclosure. The many features and advantages of the disclosure are apparent from the detailed specification, and, thus, it is intended by the appended claims to cover all such features and advantages of the disclosure which fall within the true spirit and scope of the disclosure. It is to be understood that the present disclosure is not limited to the embodiment(s) described above, but encompasses any and all embodiments within the scope of the following claims. Since numerous modifications and variations will readily occur to those of ordinary skill in the art, it is not desired to limit the disclosure to the exact construction and operation illustrated and described, and, accordingly, all suitable modifications and equivalents may be resorted to that fall within the scope of the disclosure.

What is claimed is:

1. A computer system for selecting HVAC products, comprising:
a screen display interface;
a memory;
a processor;
a network interface; and
a program that, when loaded in to the memory and executed by the processor, causes the processor to:
query a residence street address and zip code;
lookup climate from zip code;
import residential data from another computer through the network interface based on residence street address;
from the imported data, extract required home information comprising square footage of living space and age;
query a type and total number of existing HVAC system(s);
estimate the size and energy efficiency of the existing HVAC system(s) from the required home information;
determine replacement HVAC products based on the type, size and energy efficiency determined in previous steps;
present and query preferences concerning the replacement HVAC products; and
dynamically present replacement HVAC products and prices for said products on the screen display interface based on the preferences specified.

2. The computer system in accordance with claim 1, wherein the program, when loaded into the memory and executed by the processor, further causes the processor to query zip code and required home information comprising square footage of living space and age.

3. The computer system in accordance with claim 2, wherein the program, when loaded into the memory and executed by the processor, further causes the processor to:
query model number(s) and total number of existing HVAC system(s); and
lookup the type, size and energy efficiency of the existing HVAC system(s) from the model number(s).

4. The computer system in accordance with claim 3, wherein the size is estimated from square footage of living space, a factor based on climate and total number of existing HVAC system(s).

5. The computer system in accordance with claim 4, wherein the estimated size equals the square footage of living space divided by the factor based on climate and the number of systems.

6. The computer system in accordance with claim 5, wherein the factor is 500.

7. The computer system in accordance with claim 6, wherein the energy efficiency is based on estimated age of the existing HVAC system(s).

8. The computer system in accordance with claim 7, wherein the estimated age of the existing HVAC system(s) is the maximum of the home age or 15 years.

9. The computer system in accordance with claim 8, wherein the energy efficiency equals the average SEER of historical HVAC equipment having an age equal to the estimated age.

10. The computer system in accordance with claim 9, wherein the preferences include temperature consistency, control type, noise, humidity, air quality and energy savings.

11. The computer system in accordance with claim 10, wherein the program, when loaded into the memory and executed by the processor, further causes the processor to:
query contact information;
lookup an HVAC professional proximal to the street address; and
schedule an appointment with the HVAC professional.

12. A non-transient computer readable storage media comprising a program that, when loaded into memory and executed by a processor in a computer, causes the processor to:
query a residence street address and zip code;
lookup climate from zip code;
import residential data from another computer through a network interface based on residence street address;
from the imported data, extract required home information comprising square footage of living space, age and climate;
query a type and total number of existing HVAC system(s);
estimate the size and energy efficiency of the existing HVAC system(s) from the required home information;
determine replacement HVAC products based on the type, size and energy efficiency determined in previous steps;
present and query preferences concerning the replacement HVAC products; and
dynamically present replacement HVAC products and prices for said products on a screen display interface based on the preferences specified.

13. The computer readable storage media in accordance with claim 12, wherein the program further causes the processor to:
query zip code and required home information comprising square footage of living space and age.

14. The computer readable storage media in accordance with claim 13, wherein the program further causes the processor to:
query model number(s) and total number of existing HVAC system(s); and
lookup the type, size and energy efficiency of the existing HVAC system(s) from the model number(s).

15. A method of selecting HVAC products, comprising:
(a) querying a residence street address and zip code;
(b) performing a lookup of climate based on zip code from a database;
(c) retrieving residential data from a computer through a network interface based on the residence street address;
(d) extracting required home information comprising square footage of living space, age and climate from the imported data;
(e) querying a type and total number of existing HVAC system(s);
(f) estimating the size and energy efficiency of the existing HVAC system(s) from the required home information; and
(g) determining replacement HVAC products based on the type, size and energy efficiency determined in previous steps.

16. The method in accordance with claim 15, further comprising:
(h) querying preferences concerning the replacement HVAC products; and
(i) presenting replacement HVAC products and prices for said products based on the preferences specified.

17. The method of claim 16, wherein estimating the size of the existing HVAC system(s) from the required home information comprises calculating the square footage of living space divided by the total number of existing HVAC system(s) and a factor based on climate.

18. The method of claim 17, wherein the factor is 500.
